(19) United States
(12) Patent Application Publication
(10) Pub. No.: US 2026/0141315 A1
(43) Pub. Date: May 21, 2026

(54) AUTOMATED RESOURCE SCHEDULING AND RESERVATION MANAGEMENT

(71) Applicant: KL IP Holdings, LLC, Denver, CO (US)

(72) Inventors: Sonya Harmon Starr, Brighton, CO (US); Michael Ellis Starr, Brighton, CO (US); Daniel Joseph Gryzmala, Broomfield, CO (US)

(73) Assignee: KL IP Holdings, LLC, Denver, CO (US)

(21) Appl. No.: 19/393,245

(22) Filed: Nov. 18, 2025

Related U.S. Application Data
(60) Provisional application No. 63/722,479, filed on Nov. 19, 2024.

(51) Int. Cl. G06Q 10/02; G06Q 10/1093; G06Q 20/10

(52) U.S. Cl. CPC G06Q 10/02; G06Q 10/1093; G06Q 20/102

(57) ABSTRACT

Systems and methods are disclosed for automated scheduling and reservation management. A user device communicates with a scheduling subsystem to provide access to one or more digital calendars. The scheduling subsystem scans data sources of one or more suppliers to identify available time slots or resources and correlates supplier availability with availability in the digital calendars to determine one or more matches. A notification identifying the matched availability is transmitted to the user device, and upon receiving an acceptance, a reservation is generated with a supplier system. A confirmation of the reservation may be transmitted to the user device and added automatically to the user’s calendar. The disclosed technology enables coordinated, real-time reservation and schedule management across multiple digital platforms.

### CROSS-REFERENCE TO RELATED APPLICATIONS

This application claims the benefit of priority to U.S. Provisional Application No. 63/722,479 filed November 19, 2024 entitled “SYSTEM AND METHOD FOR MANAGEMENT OF GOLF-RELATED ACTIVITIES,” the entire contents of which are hereby expressly incorporated herein by this reference including, without limitation, the specification, claims, and abstract, as well as any figures, tables or drawings thereof.

### TECHNICAL FIELD

The present disclosure relates to computer-implemented systems and methods for automated scheduling and reservation management. More particularly, the disclosure relates to distributed computing architectures that coordinate availability between user calendars and supplier systems to automatically identify, reserve, and manage resources, activities, or events across multiple digital platforms.

### BACKGROUND

Coordinating reservations and scheduled activities across multiple venues, service providers, and personal calendars can be complex and time-consuming. Users often search manually across different websites or platforms to identify available times, compare options, and complete bookings. At the same time, service providers frequently manage availability using independent scheduling systems that do not communicate with user calendars or integrate with centralized booking applications. As a result, users may encounter missed opportunities, scheduling conflicts, or inefficient back-and-forth communication during the reservation process.

Existing digital tools generally require a user to repeatedly initiate searches, submit separate reservation requests, or manually reconcile bookings with personal calendars or schedules. These approaches typically lack automated matching of availability across user and supplier systems, and do not provide coordinated workflows that streamline confirmation, payments, and itinerary management. There is therefore a need for improved computer-implemented systems and methods that automatically correlate user availability with supplier availability, notify users of relevant matches, and facilitate seamless reservation execution and calendar synchronization across distributed computing environments.

### SUMMARY

In some aspects, the techniques described herein relate to a computer-implemented method for automated reservation and schedule management, the computer-implemented method including: by one or more computing devices: receiving, from a user associated with a user device, a request to reserve a resource; transmitting a request to the user device to access digital calendars associated with the user device; scanning online systems of one or more suppliers for availability for the resource; identifying instances where availability in the digital calendars matches supplier availability for the resource; transmitting a notice to the user device of the matched resource; receiving an acceptance of the matched resource by the user; generating a reservation with supplier system for the matched resource; and transmitting a booked reservation notice to the user.

In some aspects, the techniques described herein relate to a system for automated reservation and schedule management, including: a storage device; and a processor communicatively coupled to the storage device, wherein the processor executes application code instructions that are stored in the storage device to cause the system to: receive, from a user associated with a user device, a request to reserve a resource; transmit a request to the user device to access digital calendars associated with the user device; scan online systems of one or more suppliers for availability for the resource; identify instances where availability in the digital calendars matches supplier availability for the resource; transmit a notice to the user device of the matched resource; receive an acceptance of the matched resource by the user; generate a reservation with supplier system for the matched resource; and transmit a booked reservation notice to the user.

In some aspects, the techniques described herein relate to a computer program product, including: a non-transitory computer-readable storage device having computer-executable program instructions embodied thereon that when executed by a computer cause the computer to generate an automated reservation and manage a schedule, the computer-executable program instructions to: receive, from a user associated with a user device, a request to reserve a resource; transmit a request to the user device to access digital calendars associated with the user device; scan online systems of one or more suppliers for availability for the resource; identify instances where availability in the digital calendars matches supplier availability for the resource; transmit a notice to the user device of the matched resource; receive an acceptance of the matched resource by the user; generate a reservation with supplier system for the matched resource; and transmit a booked reservation notice to the user.

The disclosed technology provides an improvement in the functioning of computer systems used for automated reservation management and digital calendar synchronization. Traditional online booking systems rely on manual user input and static search queries that must be repeated across multiple platforms.

In contrast, the disclosed system implements a distributed architecture of network-connected modules, including a data acquisition system, scheduling system, and user computing device, configured to automatically and continuously correlate user calendar data with third-party supplier availability. This real-time data-driven correlation, enabled by automated calendar parsing, rule-based filtering, and machine-to-machine messaging, allows the computer system to execute coordinated reservation and payment actions without manual intervention.

These operations improve computer functionality by reducing redundant network queries, minimizing processor and bandwidth utilization, and optimizing data transmission through asynchronous communication between local and remote systems. The disclosed technology therefore constitutes a specific improvement in the operation of computer systems that execute resource-matching and scheduling functions across distributed computing environments, rather than merely implementing a generic business practice on a computer.

In certain embodiments, any of the operations described herein, such as identifying availability matches, filtering search results, generating predictive notifications, or interpreting subscriber requests, may be implemented using machine-learning techniques in addition to, or as an alternative to, rule-based algorithms. For example, the system may employ predictive models to score or rank potential resources, or natural-language processing to interpret free-form subscriber input. The system remains fully operable without such techniques, and all AI-based embodiments described herein are optional and non-limiting.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 – A block diagram depicting a portion of a communications and processing architecture of a system to acquire and process reservation requests from a user computing device, in accordance with certain examples of the technology disclosed herein.

FIG. 2 – A block flow diagram depicting steps of a method for automated golf booking, in accordance with certain examples of the technology disclosed herein.

FIG. 3 – A block flow diagram depicting a method for system coordination of golf booking and subscriber calendar, in accordance with certain examples of the technology disclosed herein.

FIG. 4 – A block flow diagram depicting a method of system coordination with suppliers, in accordance with certain examples of the technology disclosed herein.

FIG. 5 - A block flow diagram depicting a method for system coordination of concierge services, in accordance with certain examples of the technology disclosed herein.

FIG. 6 - A block diagram depicting a method for system coordination of events, in accordance with certain examples of the technology disclosed herein.

FIG. 7 - A block diagram depicting a method for system coordination of group events, in accordance with certain examples of the technology disclosed herein.

FIG. 8 - A block diagram depicting a method for subscriber notification of promotions, in accordance with certain examples of the technology disclosed herein.

FIG. 9 - A block diagram depicting a method for system coordination of suppliers, in accordance with certain examples of the technology disclosed herein.

FIG. 10 - A block diagram depicting a method for subscriber provided supplier reviews, in accordance with certain examples of the technology disclosed herein.

FIG. 11 - A block diagram depicting a method for system coordination of concierge services, in accordance with certain examples of the technology disclosed herein.

FIG. 12 - A block diagram depicting a method for system coordination of subscriber search requests, in accordance with certain examples of the technology disclosed herein.

FIG. 13 - A block diagram depicting a method for system coordination and payment of events, in accordance with certain examples of the technology disclosed herein.

FIG. 14 – An example of a graphical user interface for a subscriber, in accordance with certain examples of the technology disclosed herein.

FIG. 15 – A further example of graphical user interface for a subscriber, in accordance with certain examples of the technology disclosed herein.

FIG. 16- – A further example of graphical user interface for a subscriber, in accordance with certain examples of the technology disclosed herein.

FIG. 17 - A further example of graphical user interface for a subscriber, in accordance with certain examples of the technology disclosed herein.

FIG. 18 – A block diagram depicting a computing machine and modules, in accordance with certain examples of the technology disclosed herein.

The figures herein are for illustrative purposes only and are not necessarily drawn to scale.

### OVERVIEW

The embodiments disclosed herein provide a system and methods to retrieve data from a user/subscriber to manage and generate reservations for activities and concierge services related thereto, as further defined below.

Standard techniques related to making and using aspects of the disclosure may or may not be described in detail herein. Various aspects of computing systems and specific computer programs to implement the various technical features described herein are well known.

The disclosed system improves computer functionality by enabling the coordinated operation of multiple software and hardware subsystems that perform event-matching and booking functions in real time. In prior systems, the process of locating and confirming reservations required repetitive client-server requests and user intervention at each step. The disclosed architecture, by contrast, employs a data acquisition server configured to continuously monitor and cache supplier data streams, while a scheduling module executes asynchronous calendar scans to identify matches between available time slots and subscriber constraints. This concurrent processing reduces latency, improves processor throughput, and eliminates redundant network requests.

Furthermore, the system’s data storage and communication structures maintain information that enables predictive caching of search results and proactive notification to users, representing a technical enhancement to conventional reservation systems. These improvements yield greater computational efficiency in handling multi-source data synchronization, increase the scalability of reservation operations across a distributed network, and improve overall system response time for end users.

In some embodiments, the scheduling module or data-acquisition subsystem may incorporate optional machine-learning components configured to enhance resource matching, anomaly detection, supplier-data normalization, or prioritization of notifications. These components may include predictive models trained on historical reservation data or natural-language processing tools used to interpret concierge-related requests. Such enhancements supplement, but do not replace, the deterministic and rule-based processes described herein.

The disclosed software modules interact through defined data objects and APIs that allow modular extensibility for additional recreational domains while maintaining synchronization integrity. The computing processes therefore achieve a novel technological result, continuous and autonomous multi-platform calendar reconciliation, that cannot be practically achieved through manual or paper-based scheduling techniques. As such, the described features constitute an improvement to the functioning of a computer system itself, by enhancing its ability to perform real-time, multi-source event scheduling, storage, and payment coordination using integrated computational processes across devices.

In an example, the system and methods provide a digital concierge for subscribers, or “members”, of the platform, in either a mobile or desktop application version, in particular providing a concierge system and method for golfers, sports enthusiasts, and adventurers. Certain features distinguish the system and methods described herein from existing tee time search engines or alerting models including, without limitation, subscriber calendar integration, for example, Outlook, iCloud, and Google calendars. The subscriber profile set up feature captures player preferences when the subscriber registers for the platform. Steady state “passive” subscribers (also referred to as “Auto-Search”) may request recurring tee times and receive perpetual push notifications of available tee times that comply with member preferences and calendar availability. Enhanced discovery utilizes user-defined “bookends”: transit and warm-up before the trip and transit home after the trip. The bookends are alternative home or work pins and determine if the subscriber had sufficient time to get to the destination, considering average commute times and traffic conditions.

The system further provides subscribers with “pace of play” date for a proposed course or venue and allows the subscriber to approve tee time and booking invitations.

In a further example, “on-demand” subscribers may request tee times in advance. The system and methods described herein schedule approved tee times with various suppliers, including, without limitation, green grass golf courses, golf instructors, tournament registrations, and golf simulator establishments.

Further, the system permits subscribers to request a particular tee time and set configurations that permit the system to automatically book the tee time without requiring the subscriber to actively approve. This accommodates the challenges of booking tee times at odd hours.

Further, the system provides a social networking function that allows subscribers to connect with other members and set up score tracking and gaming applications.

The system and methods described herein may be a travel concierge for golf-centric travel. The travel concierge for golf-centric travel system and methods further integrates course maintenance information, such as aeration, cart restrictions, hole closures, tee mods, etc. and provides the subscriber with any modified amenity schedules or product availability. The system and methods further provide the subscriber with supplier special promotions, such as prospective membership events or events hosted by private/members-only golf clubs, for example, and assists in arranging tee time/events for medium to large golf groups.

In an example, the system and methods described herein further provide a co-branding and promotional platform. Examples include, without limitation, gifting opportunities pushed to players for third parties (“apology tour”), such as flowers, jewelry, miscellaneous gifts, etc.

In an example, the system may provide links to lifestyle promotions, including, without limitation, tourism, experiences, dining, gift cards, meal prep services, etc., to make up for a member’s “questionable time management.”

In an example, the system and methods disclosed herein provide links to home services to the subscriber at a discount so players can outsource home responsibilities, for example, by providing links to Ask Angi, Handyman Hug, Thumbtack, lawn services, etc.

In an example, the system and methods disclosed herein provide the subscriber with gifting opportunities, such as promotions for golf merchandise (apparel, equipment, experiences, Short Par 4 apparel subscription, High Camp Flasks, as an example, and other merchandise).

In an example, the travel concierge system and methods enable the subscriber to pre-order food and beverages at the golf course or golf simulator establishment, and allows the subscriber, for an add-on charge, to book further out, for example, 10-15 days rather than the standard 8 days.

In an example, the travel concierge system and methods provide the subscriber the ability to enter a review of amenities and to participate in in-app chats with other subscribers.

In an example, the system and methods described herein assist subscribers in booking travel-related appointments, for example, car, hotel flight and other transit reservations; excursions, events. Further, the system and methods described herein assist enthusiasts to connect in other recreational sports and activities, in addition to golf-related activities, including, but not limited to, pickleball, tennis, pick-up basketball, kickball, softball, skiing/snowboarding, soccer, volleyball, lacrosse, water sports, and other outdoor activities.

In an example, the system and methods described herein provide subscribers with travel concierge services for other interests, including but not limited to sports and physical activities; spa services, specialty interests and hobbies, such as food (cooking, restaurants, agriculture); beverage (wine; beer; sprits; coffee; tea); the arts; and miscellaneous niche interests. Further, the system and methods provide a co-branding platform for the above interests.

In certain embodiments, the system’s travel-planning or concierge-style functions may be augmented with machine-learning models that assist in identifying itinerary options, recommending destinations or activities, or refining trip parameters based on subscriber feedback. These optional AI-driven enhancements may generate or adjust itinerary proposals in response to user preferences, historical behavior, or contextual factors such as seasonal availability patterns.

In an example, the system and methods described herein further provide an in-app score-keeping function for players who wager on golf-centric betting games (e.g., Bingo/Bango/Bongo, Wolf, etc.). The commissioner may assign handicaps if the subscriber does not have one, and payment/transactions may occur in the app among members if desired.

In an example, the system and methods described herein further provide an in-app fantasy golf league with commissioners, in which payment/transactions may occur in the app among the members if desired.

In an example, the system and methods described herein enable subscribers to tailor the app features to their particular golf level. For example, “passive subscribers/auto-search” may include full-time workers who seek app push notifications of real-time golf opportunities while still prioritizing their careers and other obligations; “on-demand” subscribers, who may be full-time workers who may opt to keep their calendars booked and still request the system to send play opportunities, who request vacation tee times, and who search for golf instructions. “Self-identified golf addicts” may include players whose top priority is golf, in that much of their discretionary time is spent golfing and/or their friend groups and identity are all rooted in the game of golf; here, the system may serve as their personal concierge.

“Suppliers” may include, without limitation, green grass public courses: public courses seeking to optimize their tee sheets, desire opportunities to promote their course and amenities, and who want to manage player expectations around total experience, course maintenance activities, cart restrictions; green grass private courses: facilities that support their members in finding alternative play opportunities when their course is unavailable due to tournaments, course maintenance, etc., and whose membership directors offer promotions to entice prospective members to play a round, learn more about being a member and benefits of club life; golf simulator business: matching burgeoning trend of golf simulator taverns and their simulation bay availability with player demand; golf instructors: connecting players with instruction services aligned with their goals and needs; and non-profit organizations: non-profits who host their charity tournaments on notoriously exclusive courses can attract players and possible donors as the system connects players to their tournaments.

In certain embodiments, machine-learning models may support suppliers by identifying optimal time periods for releasing promotions or updating availability, highlighting patterns of high or low demand, or detecting outdated or inconsistent supplier information. These optional AI-driven capabilities may assist suppliers in maintaining accurate profiles and improving utilization of available facilities or service offerings.

In the disclosed embodiments, the term “resource” is used broadly to encompass any item, facility, service, activity, or time-based allocation that may be reserved, scheduled, or otherwise managed through the system. A resource may include, for example, a tee time, a simulator bay, a hotel room, a transportation booking, a spa appointment, or any other physical or digital service requiring temporal allocation. The system’s scheduling module treats each such entity as a structured data object having attributes such as availability, location, price, duration, and associated supplier information.

By normalizing these attributes across disparate supplier systems, the disclosed architecture enables uniform handling of diverse resource types within a single computational framework. Thus, the same data acquisition and correlation processes that match user calendars to golf-related availability may also apply to broader classes of recreational, travel, or lifestyle resources.

In some embodiments, supplier-provided data may be processed using AI-based classification or normalization techniques to identify facility attributes, availability windows, pricing, policies, promotions, maintenance periods, or other supplier-defined parameters. Machine-learning models may assist in correcting incomplete information, detecting inconsistencies across supplier feeds, or transforming heterogeneous data formats into standardized resource objects used by the scheduling and matching systems described herein.

In some embodiments, these data-correlation processes may be supplemented by machine-learning models configured to classify supplier resources, infer subscriber preferences, or improve availability predictions.

In some embodiments, the matching and scanning operations may be augmented by machine-learning models configured to rank or score available opportunities according to predicted relevance to subscriber preferences or past acceptance behavior. These models may further estimate when suppliers are likely to release new availability or forecast the probability that a particular opportunity will be accepted by the subscriber. Such predictive capabilities may be used to prioritize notifications, optimize scanning intervals, or accelerate booking operations.

### Example System Architectures

Referring to the drawings, in which like numerals represent like (but not necessarily identical) elements throughout the figures, example embodiments are described in detail.

The architecture described herein supports management of diverse resources. A “resource” may represent any reservation-eligible entity that can be identified in supplier data feeds and associated with a temporal interval, including but not limited to venues, facilities, services, events, or combinations thereof. Each resource record may include metadata describing its temporal availability, geographic coordinates, supplier identifier, and reservation constraints. The data acquisition system collects and indexes such resource records from multiple supplier networks, allowing the scheduling system to perform cross-domain matching against subscriber calendar data. In certain embodiments, resources may be grouped hierarchically. For example, a “trip” resource may include subordinate lodging, dining, and activity sub-resource to support composite bookings within a unified itinerary.

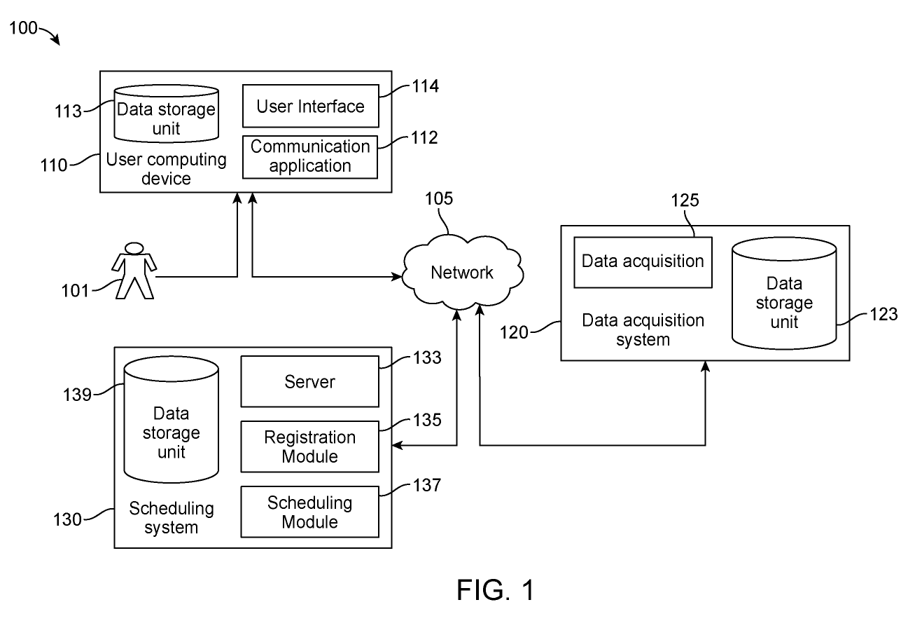

FIG. 1 is a block diagram depicting system 100 to automatically generate and manage a reservation for an activity for a subscriber to the system. In one example embodiment, a user 101 associated with a user computing device 110 must install an application, and or make a feature selection to obtain the benefits of the techniques described herein.

As depicted in FIG. 1, the system 100 includes network computing devices/systems 110, 120, and 130 that are configured to communicate with one another via one or more networks 105 or via any suitable communication technology.

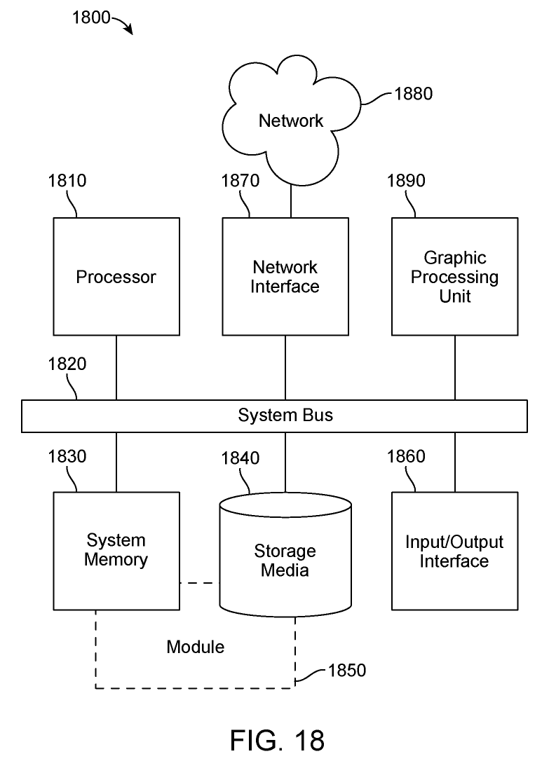

Each network 105 includes a wired or wireless telecommunication means by which network devices/systems (including devices 110, 120, and 130) can exchange data. For example, each network 105 can include any of those described herein such as the network 1880 described in FIG. 18 or any combination thereof or any other appropriate architecture or system that facilitates the communication of signals and data. Throughout the discussion of example embodiments, it should be understood that the terms “data” and “information” are used interchangeably herein to refer to text, images, audio, video, or any other form of information that can exist in a computer-based environment. The communication technology utilized by the devices/systems 110, 120, and 130 may be similar networks to network 105 or an alternative communication technology.

Each network computing device/system 110, 120, and 130 includes a computing device having a communication module capable of transmitting and receiving data over the network 105 or a similar network. For example, each network device/system 110, 120, and 130 can include any computing machine 1800 described herein and found in FIG. 18 or any other wired or wireless, processor-driven device. In the example embodiment depicted in FIG. 1, the network devices/systems 110, 120, and 130 are operated by user 101 and data acquisition system operators.

The user computing device 110 includes a user interface 114. The user interface 114 may be used to display a graphical user interface and other information to the user 101 to allow the user 101 to interact with the data acquisition system 120 and others. The user interface 114 receives user input for data acquisition and/or machine learning and displays results to user 101. In another example embodiment, the user interface 114 may be provided with a graphical user interface by the data acquisition system 120. The user interface 114 may be accessed by the processor of the user computing device 110. The user interface may display 114 may display a webpage associate with the data acquisition system 120. The user interface 114 may be used to provide input, configuration data, and other display direction by the webpage of the data acquisition system 120. In another example embodiment, the user interface 114 may be managed by the data acquisition system 120 or others. In another example embodiment, the user interface 114 may be managed by the user computing device 110 and be prepared and displayed to the user 101 based on the operations of the user computing device 110.

The system may further employ predictive models to infer subscriber preferences, including preferred distance ranges, time-of-day windows, budget thresholds, commonly selected supplier types, or frequently accepted resource categories. These inferred preferences may be used to refine search parameters, adjust notification rules, or proactively identify opportunities likely to satisfy the subscriber’s interests.

The user 101 can use the communication application 112 on the user computing device 110, which may be, for example, a web browser application or a stand-alone application, to view, download, upload, or otherwise access documents or web pages through the user interface 114 via the network 105. The user computing device 110 can interact with the web servers or other computing devices connected to the network, including the data acquisition server 125 of the data acquisition system 120. In another example embodiment, the user computing device 110 communicates with devices in the data acquisition system 120 via any other suitable technology, including the example computing system described below.

The user computing device 110 also includes a data storage unit 113 accessible by the user interface 114, the communication application 112, or other applications. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory accounts or removable flash memory. In another example embodiments, the data storage unit 113 may reside in a cloud-based computing system.

An example data acquisition system 120 comprises a data storage unit 123 and an acquisition server 125. The data storage unit 123 can include any local or remote data storage structure accessible to the data acquisition system 120 suitable for storing information. The data storage unit 123 can include one or more tangible computer-readable storage devices, or the data storage unit 123 may be a separate system, such as a different physical or virtual machine or a cloud-based storage service.

In one aspect, the data acquisition server 125 communicates with the user computing device 110 to transmit requested data. The data may include availability relating to recreational facilities, including, but not limited to, green grass golf course, golf instructors, tournament registration, golf similar establishments, and related concierge services.

The data storage unit 139 can include any local or remote data storage structure suitable for storing information. The data storage unit 139 can include one or more tangible computer-readable storage devices, or the data storage unit 139 may be a separate system, such as a different physical or virtual machine or a cloud-based storage service. Further, the scheduling system, block 130, may include a server, block 133, a registration module, block 135, and a scheduling module, block 137.

In an alternate embodiment, the functions of the data acquisition system 120 may be performed by the user computing device 110.

It will be appreciated that the network connections shown are examples, and other means of establishing a communications link between the computers and devices can be used. Moreover, those having ordinary skill in the art having the benefit of the present disclosure will appreciate that the user computing device 110, and the data acquisition system 120 illustrated in FIG. 1 can have any of several other suitable computer system configurations. For example, a user computing device 110 embodied as a mobile phone or handheld computer may not include all the components described above.

In example embodiments, the network computing devices and any other computing machines associated with the technology presented herein may be any type of computing machine such as, but not limited to, those discussed in more detail with respect to FIG. 18. Furthermore, any modules associated with any of these computing machines, such as modules described herein or any other modules (scripts, web content, software, firmware, or hardware) associated with the technology presented herein may by any of the modules discussed in more detail with respect to FIG. 18. The computing machines discussed herein may communicate with one another as well as other computer machines or communication systems over one or more networks, such as network 105. The network 105 may include any type of data or communications network, including any of the network technology discussed with respect to FIG. 18.

### Example Processes

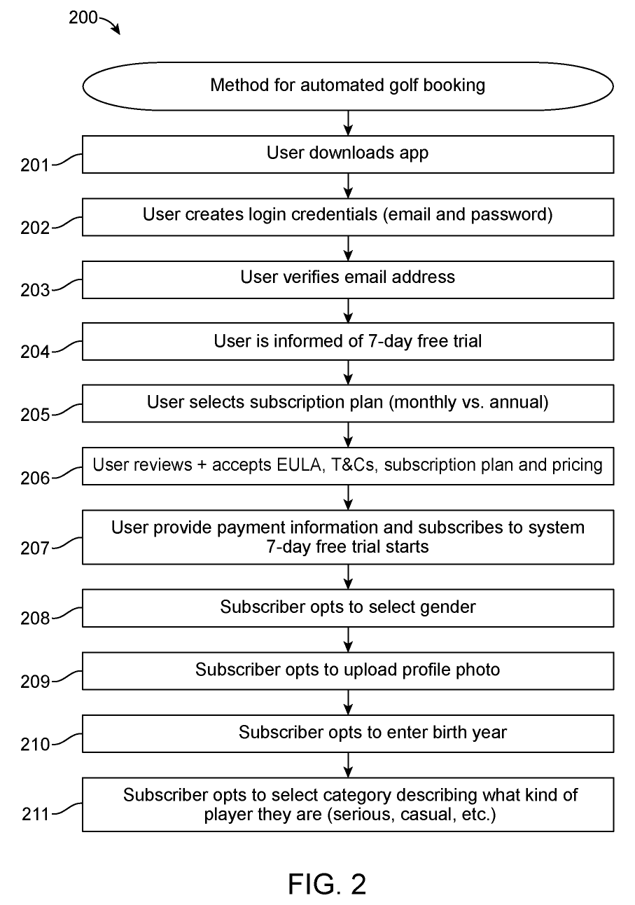

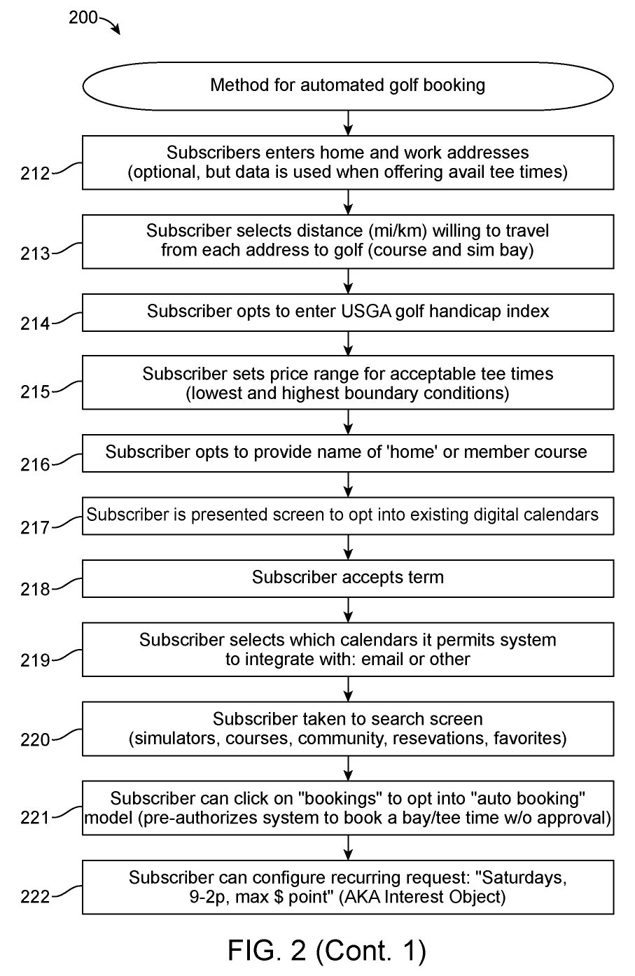

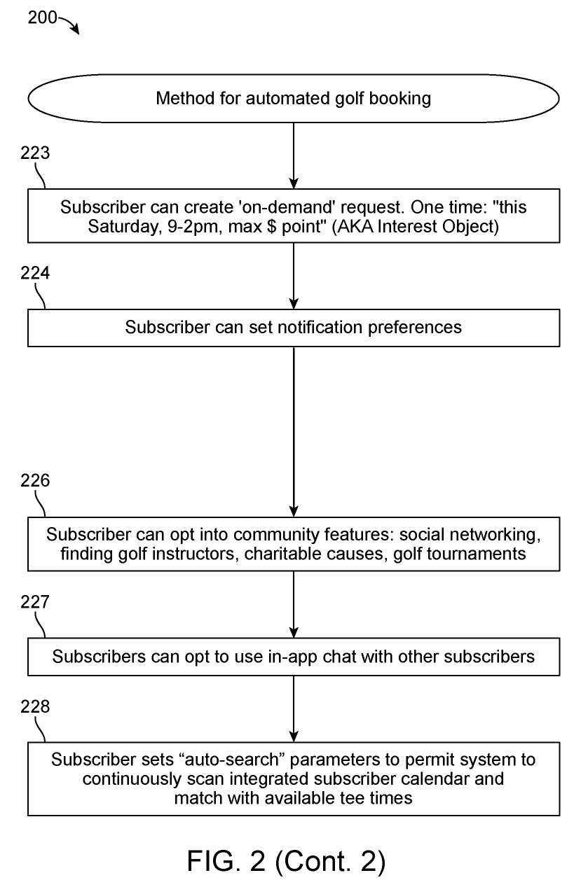

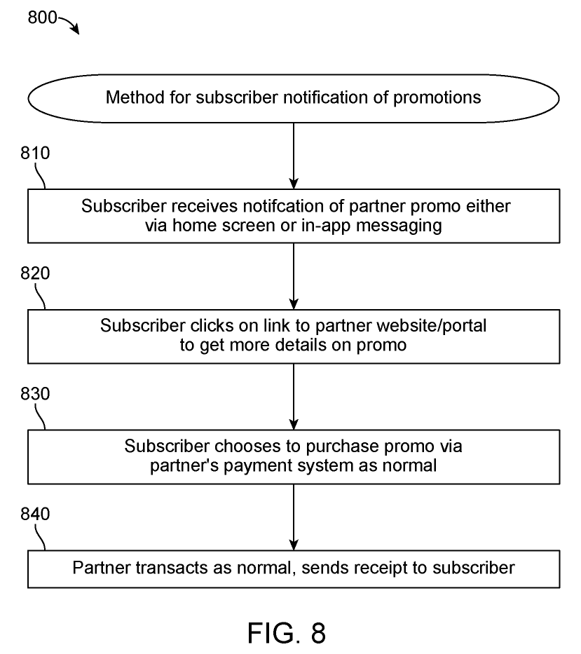

The example methods illustrated in FIGS. 2-17 are described hereinafter with respect to the components of the example architecture 100. The example methods also can be performed with other systems and in other architectures including similar elements.

Although particular examples below reference golf-related activities for clarity, the same computational processes apply to any reservable resource. The system dynamically maps a subscriber’s availability to supplier resource availability irrespective of domain, allowing seamless reservation of recreation, travel, or service-oriented resources. Thus, operations such as scanning supplier data, identifying calendar matches, transmitting reservation confirmations, and integrating payment processing are context-independent functions executed by the underlying scheduling architecture.

Referring to FIG. 2, and continuing to refer to FIG. 1 for context, a block flow diagram illustrates methods 200 for automated golf booking, in accordance with certain examples of the technology disclosed herein.

In block 201, the user downloads a mobile application (“app”) for the system on a user device, such as a smart phone, computer, or other device. Once the app is downloaded, the user creates login credentials by providing email and setting a password for a subscriber account, in block 202. The user verifies their email address with the system in block 203, and the system notifies the user of a 7-day free trial offer in block 204.

After accepting the 7-day free trial offer, the system offers the user a selection of subscription plans in block 205, from which the user can select a monthly or annual subscription plan, for example. The system generates EULA, T&C’s, the selected subscription plan, and relevant pricing for the selected plan, which are reviewed and accepted by the user in block 206 if the user intends to proceed with purchasing a subscription plan. The user then provides payment information, thereby subscribing to the system and initiating a 7-day free trial in block 207.

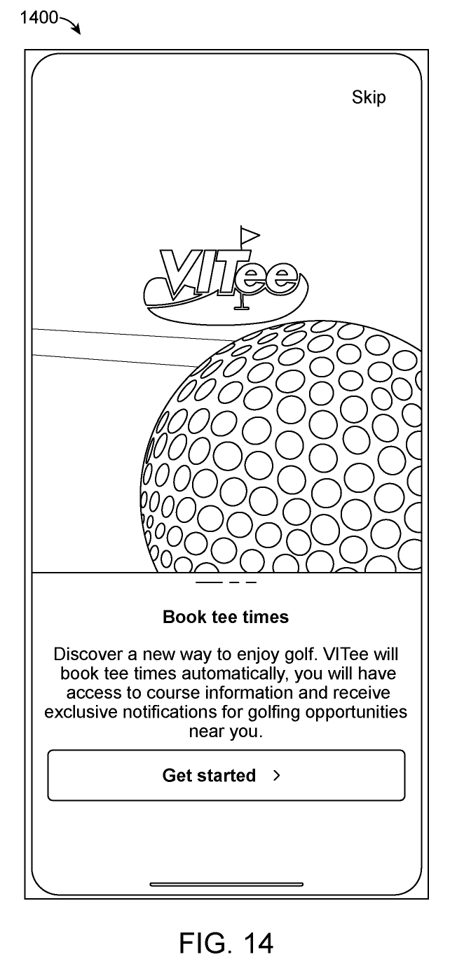

As described below with reference to FIGS. 14-16, user data is entered into the system via a graphical user interface. In blocks 208 and 209, the user may optionally select a gender or upload a profile photo, respectively, into the system via the graphical user interface. After the subscriber enters their birth year (optional) in block 210, the system provides a prompt to the subscribe, requesting selection of a category describing “what kind of player” the subscriber is, for example “serious,” “casual”, etc., and the subscriber has the option of selecting the appropriate category in block 211.

In an example, in order for the system to provide the most relevant course locations to the subscriber, the system requests the subscriber to optionally enter home and work addresses, which is entered by the subscriber in block 212. The system uses the home and work address data when offering available tee times. In block 213, the system requests the subscriber to select a distance in miles or kilometers the subscriber is willing to travel from each of the home or work addresses in order to golf, either at a golf course or at a simulated bay. In block 214, the system requests the subscriber to optionally provide a USGA golf handicap, and next requests the subscriber to set a price range for acceptable tee times by providing the highest and lowest pricing boundary conditions in block 215. The system requests the subscriber to optionally provide the name of any “home” or member course with which the subscriber is affiliated and the subscriber enters any relevant data in block 216.

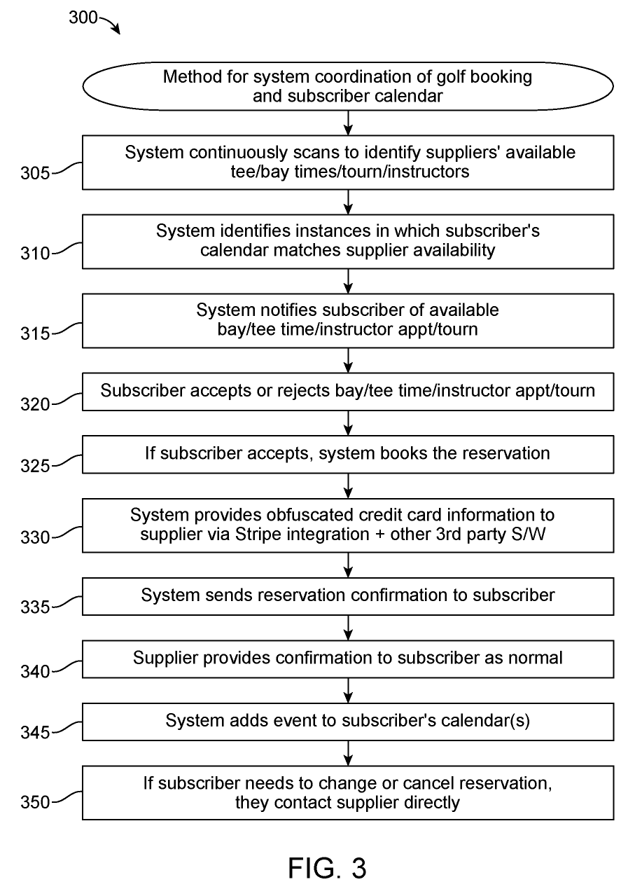

In block 217, the system presents the subscriber with a GUI/screen to optionally integrate the subscriber’s existing digital calendars, as well also to be described with reference to FIG. 3. The system provides terms to the subscriber regarding coordination with the subscriber’s existing digital calendars and if accepted by the subscriber in block 218, the subscriber then selects from a display with which calendars the subscriber permits the system to integrate, for example, email or other calendars in block 219.

In block 220, the system then provides the subscriber with a search screen by means of which the subscriber can search from fields such as, but not limited to, golf simulators, golf courses, communities, reservations, favorites. Subscriber is offered an option to select “bookings” to opt into an “auto booking model” in block 221. The auto booking model authorizes the system to book a simulator bay or golf course tee time without pre-approval by the subscriber.

The system offers the subscriber displays so that the subscriber can configure a recurring request, for example, “Saturdays, from 9 a.m. to 2 pm” with a maximum price point, also known in the system as an “Interest Object,” as depicted in block 222. In another example depicted in block 223, the subscriber is offered the option to create an “on demand” request, such as a one-time request, for example “this Saturday, 9 am – 2 pm”, again with a maximum price point (also known as an “Interest Object” in the system.

In block 224, the system provides options for the subscriber to set notification preferences. Further, the system provides the subscriber with a display allowing the subscriber to opt into community features, such as social networking, searching for golf instructors, charitable causes, or golf tournaments, as depicted in block 226. The system further offers the subscribers the opportunity to opt into use an in-app chat with other subscribers to the system depicted in block 227. The subscriber may set “auto-search” parameters to permit system users to continuously scan integrated subscriber calendar(s) and match with available tee times 228.

FIG. 3. depicts a method for system coordination of a golf booking with a subscriber calendar 300. In block 305, the system continuously scans to identify available tee or bay times, tournaments, or instructors at various suppliers, including, but not limited to, golf courses, golf simulators, recreational facilities and others. When the system identifies instances in which a subscriber’s calendar matches with a supplier’s availability in block 310, the system notifies the subscriber of available simulator bay times, tee times, instructor appointment times, or tournament times in block 315. In block 320, the subscriber accepts or rejects the notified bay, tee, instructor or tournament time transmitted by the system. The system books a reservation with the supplier reservation for the subscriber in block 325, if the subscriber accepts the transmitted available time.

In order to further facilitate the booking process, in block 330, the system provides the subscriber’s obfuscated credit card information to the supplier, for example via Stripe integration or any other third party software solution that handles the secure transfer of funds. In block 335, the system transmits the reservation confirmation received from the supplier to the subscriber, and the supplier also provides confirmation to the subscriber in block 340. The system adds the event to the subscriber’s calendar(s) (block 345); if the subscriber must change or cancel the reservation, the subscriber contacts the supplier directly (block 350).

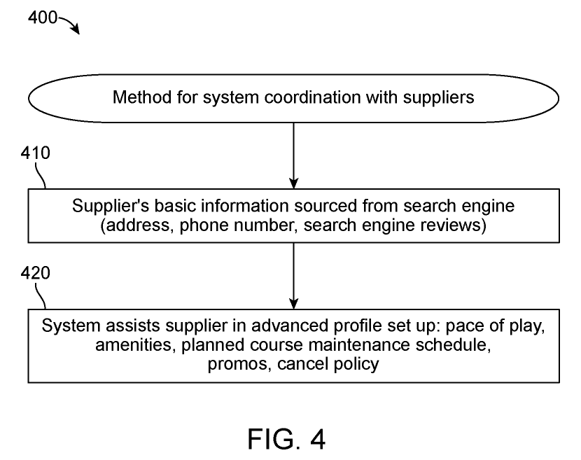

With regard to coordination with suppliers, for example, golf simulators, golf courses and communities, golf tournaments, charities, and instructors, FIG. 4 depicts a method for the system to coordinate with suppliers 400, in which in block 410, a supplier’s basic information is searched by the system from a search engine. Basic information may include information such as address, telephone number, and search engine reviews, by way of example. In block 420, the system assists the supplier in preparing an advanced profile of the supplier that may be reviewed by a subscriber. By way of example, the supplier’s profile may include information such as pace of play, amenities, planned course maintenance schedule, promotions, and cancellation policies.

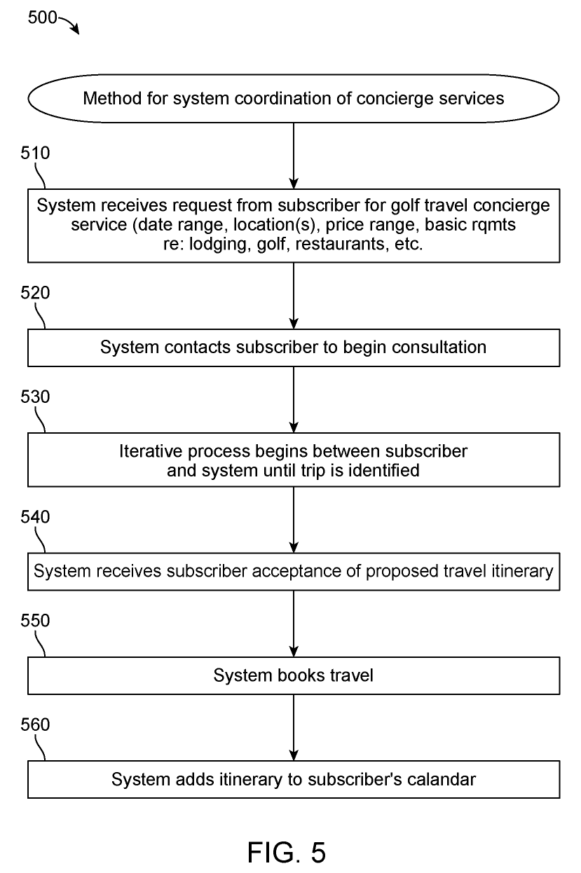

FIG. 5 provides an example of a method for system coordination of concierge services 500 related to a golf booking made through the system. In block 510, the system receives a request from the subscriber for golf travel concierge services. The request may include a range of requested dates or the travel preferred location(s), price ranges, and further basic requirements, for example, lodging, golf options, dining options, spa services. Upon receipt of the request, in block 520, the system contacts the subscriber to begin consultation regarding the requested concierge service, and an iterative process begins between the subscriber and system until a trip is defined 530. For example, the system may provide additional queries to the subscriber to focus the search on particular types of golf venues, lodging options, and dining preferences until the trip is clearly defined and narrowed. Once a trip is defined within the requested parameters and is accepted by the subscriber, the system books the travel and other services selected by the subscriber for the defined trip and adds the itinerary to the subscriber’s calendar(s). (See blocks 540, 550, and 560).

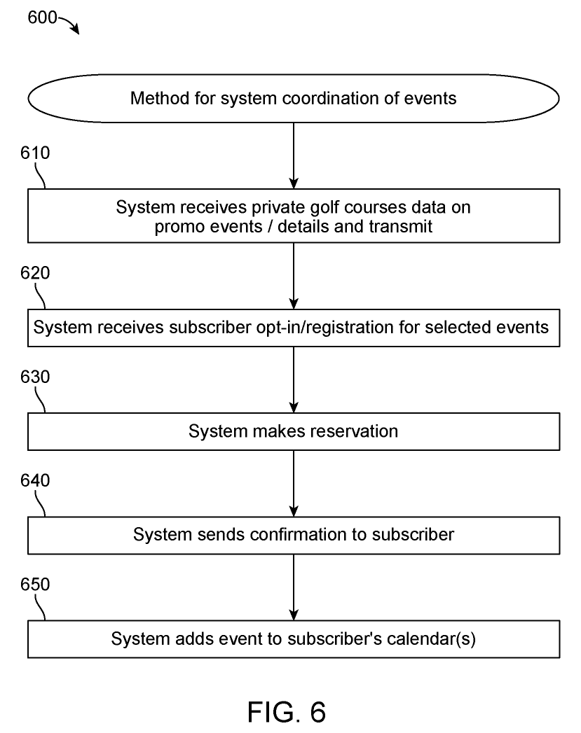

FIG. 6 depicts a system or coordination of events 600, in which the system receives private golf course data regarding details on promotion events, for example, and transmits the event details to the subscriber 610. The system receives the subscriber's opt-in registration for any selected events transmitted to the subscriber by the system in block 620 and makes a reservation for the subscriber for the selected event(s) in block 630. In blocks 640 and 650, the system transmits a confirmation of the event reservation to the subscriber and adds the event the subscriber’s calendar(s), respectively.

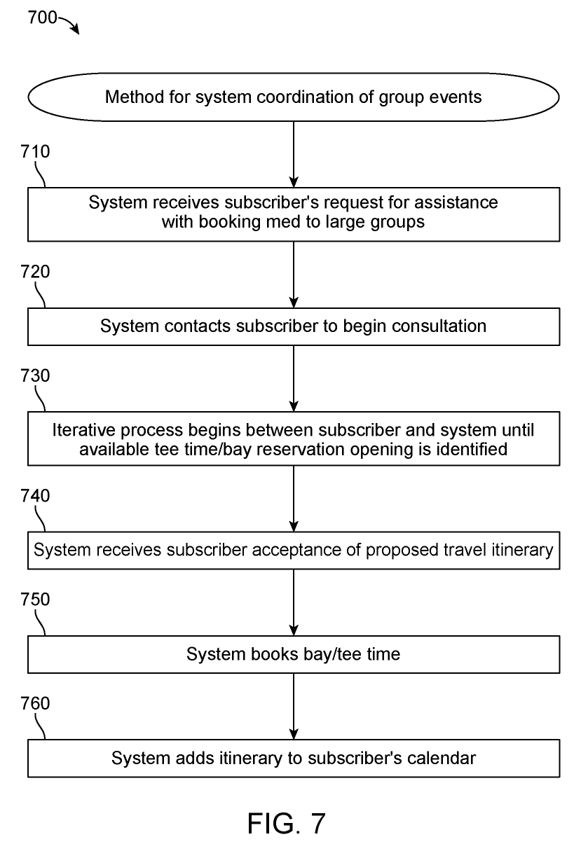

FIG. 7 describes a method for system coordination of group events 700, in which the system receives a subscriber’s request or assistance with booking a golf-related event for a medium to large size group in block 710. Alter the system contacts the subscriber to begin consultation in block 720, an iterative process begins between the subscriber and the system until a tee time or bay opening is defined and identified. In the iterative process, the subscriber may respond to queries made by the system to narrow down and accurately determine the subscriber’s preferences for the group event, such as location, travel date ranges, dining and lodging options, etc., in block 730. Once a group trip is defined, the system receives the subscriber’s acceptance of the proposed group trip itinerary in block 740 and books the simulated bay or golf tee time for the group in block 750. The system then adds the itinerary to the subscriber’s calendar in block 760.

In an example, the system provides a method for subscriber notification of promotions 800. The subscriber may receive notifications of supplier/partner promotions, either via the subscriber’s home screen on their device or via in-app message in block 810. The system provides a link for the subscriber to click on that will lead the subscriber to the partner website or portal to obtain details on the promotion in block 820. If the subscriber choses to purchase the promotion, the subscriber pays for the promotion via the partner’s payment system offered on the partner’s website, and the partner processes the transaction and sends a receipt to the subscriber (830, 840, respectively).

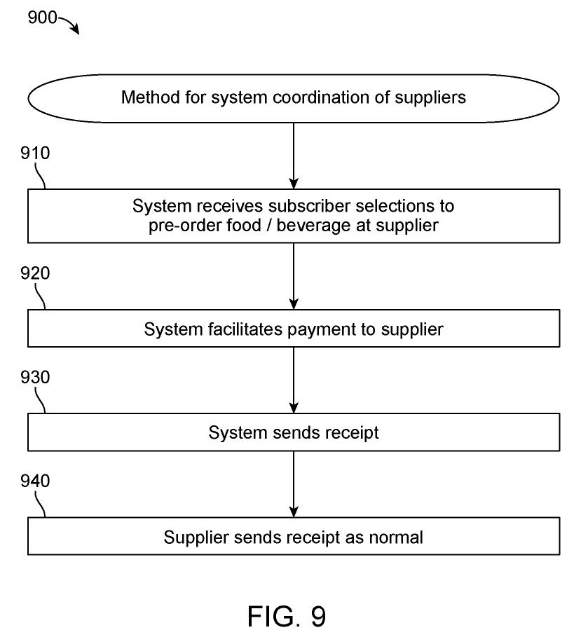

FIG. 9 shows a method for system coordination of suppliers 900, in which the system receives a subscriber’s selection of food or beverages for pre-order at a supplier, for example, a golf course, golf community, or golf simulator facility in block 910. The system facilitates payment by the subscriber to the supplier, for example, by providing a payment portal or a link to the supplier’s payment portal, and sends a receipt to the subscriber in blocks 920, 930, respectively. The supplier also sends a receipt as in their normal process to the subscriber for their purchase in block 940.

In some embodiments, anomaly-detection models may be employed to identify irregularities in booking requests, supplier confirmations, payment-related data, or conflicting availability responses. Upon detection, the system may temporarily suspend processing, request verification from the subscriber or supplier, or initiate corrective actions to ensure accurate reservation execution and protect transaction integrity.

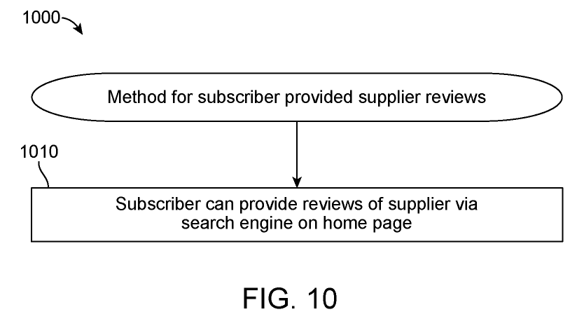

The system may provide a method for subscriber provided supplier reviews 1000, as shown in FIG. 10, in which the system provides an interface to the subscriber to enter a review of the supplier via a search engine on the system’s home page (block 1010).

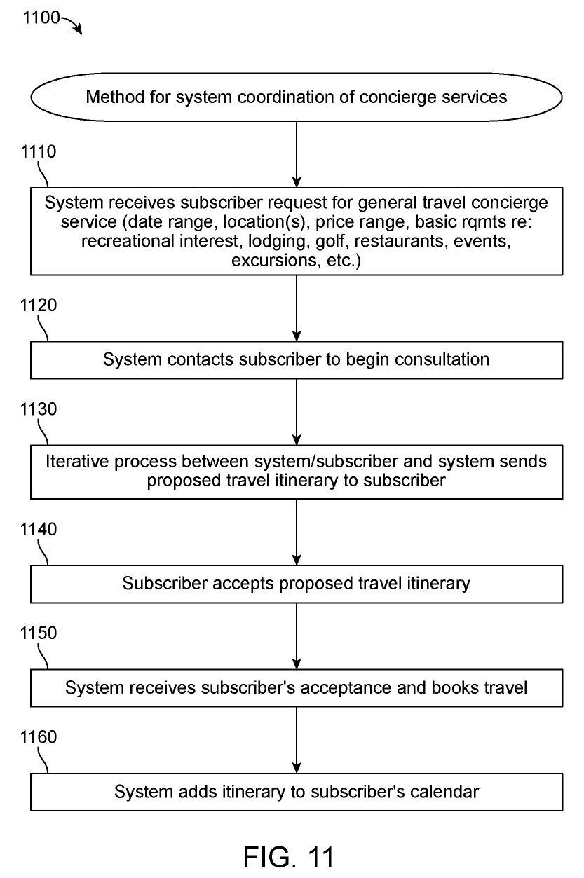

In an example, as shown in FIG. 11, the system provides a method for system coordination of concierge services 1100, not necessarily relating to golf events or schedule. For example, in block 1110, the system may receive a subscriber’s request for general travel concierge services. The subscriber may provide the system with travel date ranges, preferred location(s), a preferred price range. Further basic requirements requested by the system may be the subscriber’s recreational interests, preferred type and price range of lodging, any interest in golf courses or other recreational event (for example, skiing/snowboarding, pickleball, rafting, rock climbing, by way of example), dining preferences, side excursions, spa services, by way of example. In block 1120, the system contacts the subscriber to begin consultation on the requested concierge services, and the iterative process between the system and subscriber is initiated in block 1130, resulting ultimately in the system sending a proposed travel itinerary to the subscriber. If the subscriber accepts the proposed itinerary in block 1140, the system receives the acceptance and books the desired itinerary for the subscriber in block 1150 and adds the itinerary to the subscriber’s calendar(s) in block 1160.

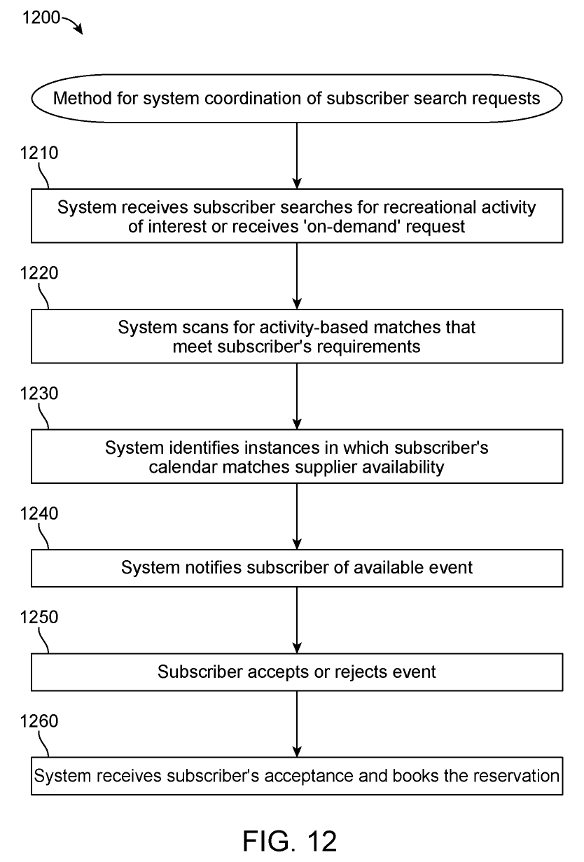

In FIG. 12, a method for system coordination of subscriber search requests 1200 is shown. In block 1210, the system receives subscriber searches for a recreational activity of interest or receives an “on-demand” request. For example, activities may include, without limitation, recreational sports, such as golf, tennis, pickleball, soccer, softball, rock-climbing, skiing, snowboarding, spa services, or any other activity of interest to the subscriber. In response to the subscriber search, the system scans for activity-based matches that meet the subscriber’s requirements via an internet search and a search of suppliers in the system, for example, according to block 1220. The system next identifies any instances in which the subscriber’s calendar matchers a supplier’s availability in block 1230 and notifies the subscriber of an available event in block 1240. The subscriber accepts or rejects the event matched by the system to the subscriber’s calendar in block 1250, and if the system receives an acceptance from the subscriber of the matched event, the system books the reservation for the subscriber in block 1260.

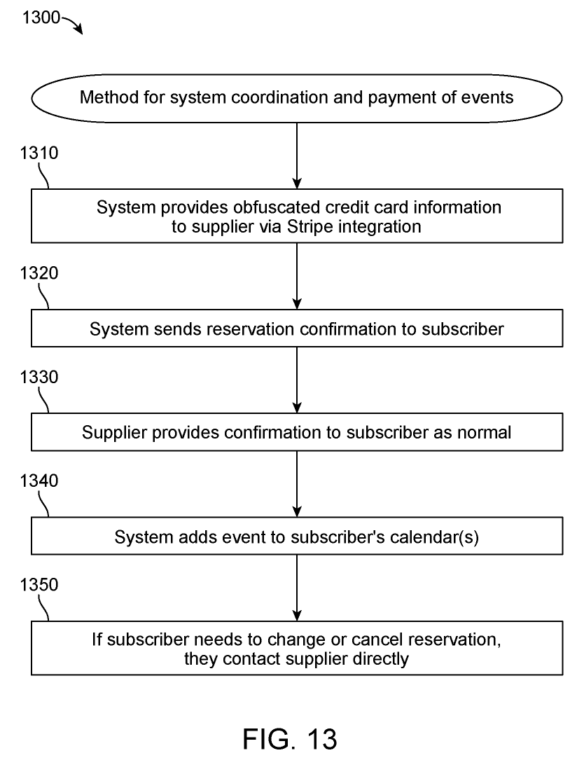

FIG. 13 depicts a method for system coordination and payments of events 1300. As described above, the system may facilitate payments by the subscriber to any suppliers with whom the subscriber may have made a reservation for an activity. In block 1310, the system may provide obfuscated credit card information to a supplier, for example, via Stripe integration. The system then sends the reservation confirmation to the subscriber in block 1320, and the supplier provided confirmation to the subscriber in standard fashion in block 1330. After confirmations are provided, the system adds the event to the subscriber’s calendar(s) in block 1340; if the subscriber needs to change or cancel a reservation, the subscriber may contact the supplier directly, block 1350.

FIGS. 14-17 show examples of graphical user interfaces that may be used in the system and methods described herein.

FIG. 14 illustrates an example graphical user interface 1400 presented to a subscriber on a mobile or desktop device. The user interface 1400 displays a personalized home screen through which the subscriber may access primary features of the system, including golf course search, simulator bay reservations, community functions, and concierge services. In one example, the display provides selectable tiles or menu icons that correspond to system functions such as “Find a Tee Time,” “Simulators,” “Concierge,” “Community,” and “Favorites.” The top region of the interface may display the subscriber’s profile name or account identifier, subscription status, and a navigation bar or menu icon for accessing settings and notifications. The graphical layout may include a notification banner presenting real-time alerts such as available tee times, travel offers, or promotions from partner facilities. Selection of a tile or icon causes the system to transition to the corresponding function module—for example, activating the golf course search engine or the concierge itinerary manager. The interface 1400 thereby operates as the subscriber’s entry point into the digital concierge system, presenting both dynamic content and persistent navigation elements in a visually intuitive layout configured for touch or pointer input.

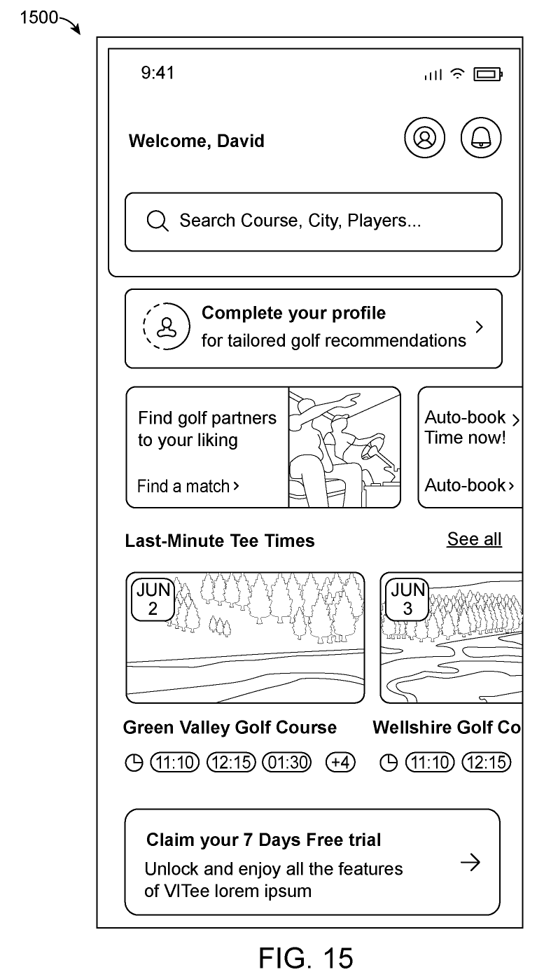

FIG. 15 illustrates a further example graphical user interface 1500 showing an active search or results screen generated after the subscriber selects a desired activity type. In the depicted example, the user interface 1500 displays a series of search results corresponding to available golf tee times, simulator bays, or instructor sessions identified by the system. Each result may be presented as a card or row including the course or venue name, distance from the subscriber’s stored location, price, available times, and any special conditions such as cart restrictions or promotions. A filter control permits the subscriber to refine results by parameters such as distance, price range, course type, or play window. A “Sort” or “Favorites” selector may allow re-ordering of results according to user preference. The interface further includes a selectable button adjacent to each result that enables the subscriber to book the displayed time manually or to authorize automatic booking under stored payment credentials. Upon confirmation, the system transmits a reservation request to the selected supplier and updates the subscriber’s digital calendar as described above. Thus, the graphical interface 1500 provides a consolidated, interactive display for browsing and booking among multiple supplier options returned by the system’s automated search.

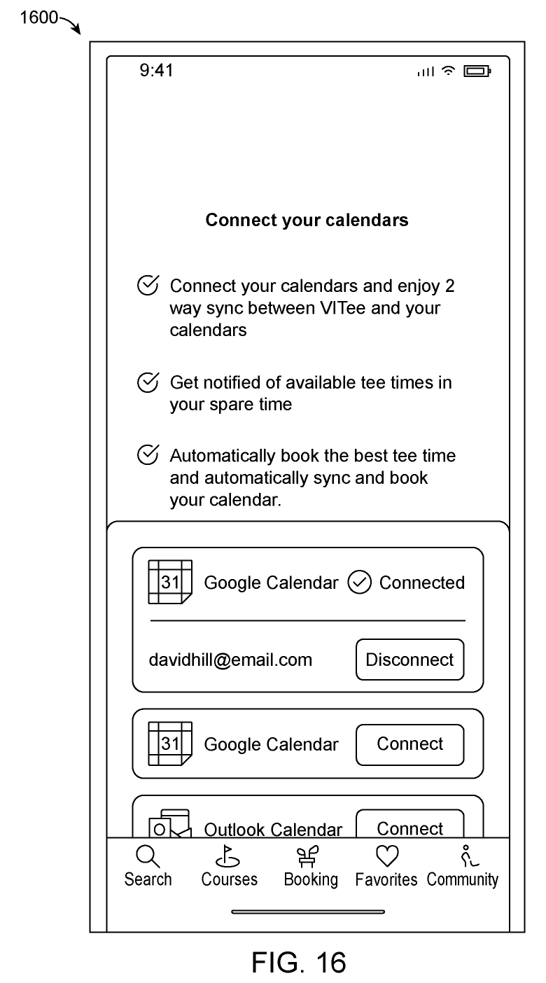

FIG. 16 depicts an additional example graphical user interface 1600 illustrating a reservation confirmation or itinerary view. The interface 1600 presents details of a reservation previously made through the system, including the facility name, address, scheduled date and time, confirmation number, and any supplemental concierge services linked to the reservation (for example, lodging, dining, or transportation). The screen may further display options for the subscriber to share the reservation with other members, to invite additional players, or to add the event to an external digital calendar. An embedded map pane or hyperlink may enable navigation to the course or facility. The bottom region of the interface can include user-action buttons such as “Cancel,” “Modify,” or “Add to Trip,” which trigger corresponding operations in the system. Real-time status indicators may show weather forecasts, pace-of-play data, or supplier messages associated with the booked event. The graphical interface 1600 thereby consolidates reservation information and post-booking controls in a single view, allowing the subscriber to manage reservations efficiently without leaving the application environment.

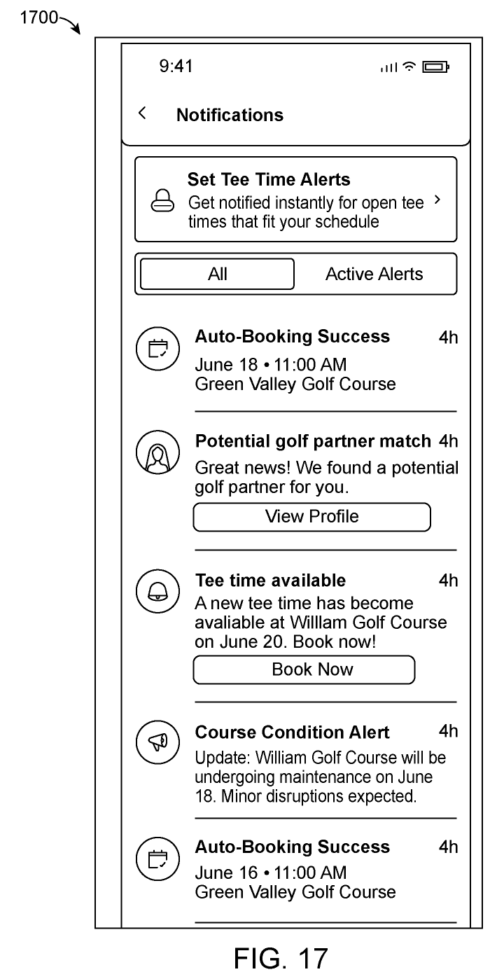

FIG. 17 illustrates a further example graphical user interface 1700 corresponding to community and social-networking features of the system. The interface 1700 may display a feed of activity updates, invitations, or messages exchanged among subscribers. In one example, the screen provides tabs or toggles for “Community,” “Chat,” “Groups,” and “Events,” allowing users to browse local tournaments, charity outings, or instructor sessions organized through the platform. A message panel permits one-to-one or group communication among subscribers to coordinate play or share experiences. The subscriber may view other members’ profiles, handicaps, and preferred courses, and may elect to “Follow,” “Invite to Round,” or “Message” a selected member. In addition, the interface may present promotional postings or sponsored events curated by suppliers, which subscribers can join directly through in-app registration. The user interface 1700 thus supports social interaction and community building among golfers and other sports enthusiasts within the integrated booking and concierge ecosystem.

The ladder diagrams, scenarios, flowcharts and block diagrams in the figures and discussed herein illustrate architecture, functionality, and operation of example embodiments and various aspects of systems, methods, and computer program products of the present disclosure. Each block in the flowchart or block diagrams can represent the processing of information and/or transmission of information corresponding to circuitry that can be configured to execute the logical functions of the present techniques. Each block in the flowchart or block diagrams can represent a module, segment, or portion of one or more executable instructions for implementing the specified operation or step. In example embodiments, the functions/acts in a block can occur out of the order shown in the figures and nothing requires that the operations be performed in the order illustrated. For example, two blocks shown in succession can be executed concurrently or essentially concurrently. In another example, blocks can be executed in the reverse order. Furthermore, variations, modifications, substitutions, additions, or reduction in blocks and/or functions may be used with any of the ladder diagrams, scenarios, flow charts and block diagrams discussed herein, all of which are explicitly contemplated herein.

The ladder diagrams, scenarios, flow charts and block diagrams may be combined with one another, in part or in whole. Coordination will depend upon the required functionality. Each block of the block diagrams and/or flowchart illustration as well as combinations of blocks in the block diagrams and/or flowchart illustrations can be implemented by special purpose hardware- based systems that perform the aforementioned functions/acts or carry out combinations of special purpose hardware and computer instructions. Moreover, a block may represent one or more information transmissions and may correspond to information transmissions among software and/or hardware modules in the same physical device and/or hardware modules in different physical devices.

The present techniques can be implemented as a system, a method, a computer program product, digital electronic circuitry, and/or in computer hardware, firmware, software, or in combinations of them. The system may comprise distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as a processor of the scheduling system 130.

The computer program product can include a program tangibly embodied in an information carrier (e.g., computer readable storage medium or media) having computer readable program instructions thereon for execution by, or to control the operation of, data processing apparatus (e.g., a processor) to carry out aspects of one or more embodiments of the present disclosure. It will be understood that each block of the flowchart illustrations and/or block diagrams, and combinations of blocks in the flowchart illustrations and/or block diagrams, can be implemented by computer readable program instructions.

The computer readable program instructions can be performed on general purpose computing device, special purpose computing device, or other programmable data processing apparatus to produce a machine, such that the instructions, which execute via, at least partially, by one or more processors that are temporarily configured (e.g., by software) or permanently configured to perform the functions/acts specified in the flowchart and/or block diagram block or blocks. The processors, either: temporarily or permanently; or partially configured, may comprise processor-implemented modules. The present techniques referred to herein may, in example embodiments, comprise processor-implemented modules. Functions/acts of the processor-implemented modules may be distributed among the one or more processors. Moreover, the functions/acts of the processor-implements modules may be deployed across a number of machines, where the machines may be located in a single geographical location or distributed across a number of geographical locations.

The computer readable program instructions can also be stored in a computer readable storage medium that can direct one or more computer devices, programmable data processing apparatuses, and/or other devices to carry out the function/acts of the processor-implemented modules. The computer readable storage medium containing all or partial processor-implemented modules stored therein, comprises an article of manufacture including instructions which implement aspects, operations, or steps to be performed of the function/act specified in the flowchart and/or block diagram block or blocks.

Computer readable program instructions described herein can be downloaded to a computer readable storage medium within a respective computing/processing devices from a computer readable storage medium. Optionally, the computer readable program instructions can be downloaded to an external computer device or external storage device via a network. A network adapter card or network interface in each computing/processing device can receive computer readable program instructions from the network and forward the computer readable program instructions for permanent or temporary storage in a computer readable storage medium within the respective computing/processing device.

Computer readable program instructions described herein can be assembler instructions, instruction-set-architecture (ISA) instructions, machine instructions, machine dependent instructions, microcode, firmware instructions, state-setting data, or either source code or object code. The computer readable program instructions can be written in any programming language such as compiled or interpreted languages. In addition, the programming language can be object-oriented programming language (e.g., “C++”) or conventional procedural programming languages (e.g., “C”) or any combination thereof may be used to as computer readable program instructions. The computer readable program instructions can be distributed in any form, for example as a stand-alone program, module, subroutine, or other unit suitable for use in a computing environment. The computer readable program instructions can execute entirely on one computer or on multiple computers at one site or across multiple sites connected by a communication network, for example on user's computer, partly on the user's computer, as a stand-alone software package, partly on the user's computer and partly on a remote computer or entirely on a remote computer or server. If the computer readable program instructions are executed entirely remote, then the remote computer can be connected to the user's computer through any type of network or the connection can be made to an external computer. In examples embodiments, electronic circuitry including, but not limited to, programmable logic circuitry, field-programmable gate arrays (FPGA), or programmable logic arrays (PLA) can execute the computer readable program instructions. Electronic circuitry can utilize state information of the computer readable program instructions to personalize the electronic circuitry, to execute functions/acts of one or more embodiments of the present disclosure.

Example embodiments described herein include logic or a number of components, modules, or mechanisms. Modules may comprise either software modules or hardware-implemented modules. A software module may be code embodied on a non-transitory machine-readable medium or in a transmission signal. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In example embodiments, a hardware-implemented module may be implemented mechanically or electronically. In example embodiments, hardware-implemented modules may comprise permanently configured dedicated circuitry or logic to execute certain functions/acts such as a special-purpose processor or logic circuitry (e.g., a field programmable gate array (FPGA) or an application-specific integrated circuit (ASIC)). In example embodiments, hardware-implemented modules may comprise temporary programmable logic or circuitry to perform certain functions/acts. For example, a general-purpose processor or other programmable processor.

The term “hardware-implemented module” encompasses a tangible entity. A tangible entity may be physically constructed, permanently configured, or temporarily or transitorily configured to operate in a certain manner and/or to perform certain functions/acts described herein. Hardware-implemented modules that are temporarily configured need not be configured or instantiated at any one time. For example, if the hardware-implemented modules comprise a general-purpose processor configured using software, then the general-purpose processor may be configured as different hardware-implemented modules at different times.

Hardware-implemented modules can provide, receive, and/or exchange information from/with other hardware-implemented modules. The hardware-implemented modules herein may be communicatively coupled. Multiple hardware-implemented modules operating concurrently, may communicate through signal transmission, for instance appropriate circuits and buses that connect the hardware-implemented modules. Multiple hardware-implemented modules configured or instantiated at different times may communicate through temporarily or permanently archived information, for instance the storage and retrieval of information in memory structures to which the multiple hardware-implemented modules have access. For example, one hardware-implemented module may perform an operation, and store the output of that operation in a memory device to which it is communicatively coupled. Consequently, another hardware-implemented module may, at some time later, access the memory device to retrieve and process the stored information. Hardware-implemented modules may also initiate communications with input or output devices, and can operate on information from the input or output devices.

In example embodiments, the present techniques can be at least partially implemented in a cloud or virtual machine environment.

One or more processors may also operate to support performance of the relevant operations in a “cloud computing” environment or as a “software as a service” (SaaS). For example, at least some of the operations may be performed by a group of computers, these operations being accessible via a network and via one or more appropriate interfaces (e.g., application program interfaces (APIs)).

### Service Models

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

A cloud computing environment is service oriented with a focus on statelessness, low coupling, modularity, and semantic interoperability. At the heart of cloud computing is an infrastructure comprising a network of interconnected nodes.

### Cloud Computing Environment

A cloud computing environment includes one or more cloud computing nodes with which local computing devices used by cloud consumers, such as, for example, personal digital assistant (PDA) or cellular telephone, desktop computer, laptop computer, and/or automobile computer system may communicate. Nodes may communicate with one another. They may be grouped physically or virtually, in one or more networks, such as Private, Community, Public, or Hybrid clouds, or a combination thereof. This allows a cloud computing environment to offer infrastructure, platforms and/or software as services for which a cloud consumer does not need to maintain resources on a local computing device. It is understood that the types of computing devices described above are intended to be illustrative only and that computing nodes and the cloud computing environment can communicate with any type of computerized device over any type of network and/or network addressable connection (e.g., using a web browser).

### Deployment Models

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

### Example Computing Device

FIG. 18 depicts a block diagram of a computing machine 1800 and a module 1850 in accordance with certain examples. The computing machine 1800 may comprise, but are not limited to, remote devices, work stations, servers, computers, general purpose computers, Internet/web appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and any machine capable of executing the instructions. The module 1850 may comprise one or more hardware or software elements configured to facilitate the computing machine 1800 in performing the various methods and processing functions presented herein. The computing machine 1800 may include various internal or attached components such as a processor 1810, system bus 1820, system memory 1830, storage media 1840, input/output interface 1860, and a network interface 1870 for communicating with a network 1880.

The computing machine 1800 may be implemented as a conventional computer system, an embedded controller, a laptop, a server, a mobile device, a smartphone, a set-top box, a kiosk, a router or other network node, a vehicular information system, one or more processors associated with a television, a customized machine, any other hardware platform, or any combination or multiplicity thereof. The computing machine 1800 may be a distributed system configured to function using multiple computing machines interconnected via a data network or bus system.

The one or more processor 1810 may be configured to execute code or instructions to perform the operations and functionality described herein, manage request flow and address mappings, and to perform calculations and generate commands. Such code or instructions could include, but is not limited to, firmware, resident software, microcode, and the like. The processor 1810 may be configured to monitor and control the operation of the components in the computing machine 1800. The processor 1810 may be a general purpose processor, a processor core, a multiprocessor, a reconfigurable processor, a microcontroller, a digital signal processor (DSP), an application specific integrated circuit (ASIC), tensor processing units (TPUs), a graphics processing unit (GPU), a field programmable gate array (FPGA), a programmable logic device (PLD), a radio-frequency integrated circuit (RFIC), a controller, a state machine, gated logic, discrete hardware components, any other processing unit, or any combination or multiplicity thereof. In example embodiments, each processor 1810 can include a reduced instruction set computer (RISC) microprocessor. The processor 1810 may be a single processing unit, multiple processing units, a single processing core, multiple processing cores, special purpose processing cores, co-processors, or any combination thereof. According to certain examples, the processor 1810 along with other components of the computing machine 1800 may be a virtualized computing machine executing within one or more other computing machines. Processors 1810 are coupled to system memory and various other components via a system bus 1820.

The system memory 1830 may include non-volatile memories such as read-only memory (ROM), programmable read-only memory (PROM), erasable programmable read-only memory (EPROM), flash memory, or any other device capable of storing program instructions or data with or without applied power. The system memory 1830 may also include volatile memories such as random-access memory (RAM), static random-access memory (SRAM), dynamic random-access memory (DRAM), and synchronous dynamic random-access memory (SDRAM). Other types of RAM also may be used to implement the system memory 1830. The system memory 1830 may be implemented using a single memory module or multiple memory modules. While the system memory 1830 is depicted as being part of the computing machine 1800, one skilled in the art will recognize that the system memory 1830 may be separate from the computing machine 1800 without departing from the scope of the subject technology. It should also be appreciated that the system memory 1830 is coupled to system bus 1820 and can include a basic input/output system (BIOS), which controls certain basic functions of the processor 1810 and/or operate in conjunction with, a non-volatile storage device such as the storage media 1840.

In example embodiments, the computing device 1800 includes a graphics processing unit (GPU) 1890. Graphics processing unit 1890 is a specialized electronic circuit designed to manipulate and alter memory to accelerate the creation of images in a frame buffer intended for output to a display. In general, a graphics processing unit 1890 is efficient at manipulating computer graphics and image processing and has a highly parallel structure that makes it more effective than general-purpose CPUs for algorithms where processing of large blocks of data is done in parallel.

The storage media 1840 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any electromagnetic storage device, any semiconductor storage device, any physical-based storage device, any removable and non-removable media, any other data storage device, or any combination or multiplicity thereof. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any other data storage device, or any combination or multiplicity thereof. The storage media 1840 may store one or more operating systems, application programs and program modules such as module 1850, data, or any other information. The storage media 1840 may be part of, or connected to, the computing machine 1800. The storage media 1840 may also be part of one or more other computing machines that are in communication with the computing machine 1800 such as servers, database servers, cloud storage, network attached storage, and so forth. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The module 1850 may comprise one or more hardware or software elements, as well as an operating system, configured to facilitate the computing machine 1800 with performing the various methods and processing functions presented herein. The module 1850 may include one or more sequences of instructions stored as software or firmware in association with the system memory 1830, the storage media 1840, or both. The storage media 1840 may therefore represent examples of machine or computer readable media on which instructions or code may be stored for execution by the processor 1810. Machine or computer readable media may generally refer to any medium or media used to provide instructions to the processor 1810. Such machine or computer readable media associated with the module 1850 may comprise a computer software product. Each of the operating system, one or more application programs, other program modules, and program data or some combination thereof, may include an implementation of a networking environment. It should be appreciated that a computer software product comprising the module 1850 may also be associated with one or more processes or methods for delivering the module 1850 to the computing machine 1800 via the network 1880, any signal-bearing medium, or any other communication or delivery technology. The module 1850 may also comprise hardware circuits or information for configuring hardware circuits such as microcode or configuration information for an FPGA or other PLD.

The input/output (I/O) interface 1860 may be configured to couple to one or more external devices, to receive data from the one or more external devices, and to send data to the one or more external devices. Such external devices along with the various internal devices may also be known as peripheral devices. The I/O interface 1860 may include both electrical and physical connections for coupling in operation the various peripheral devices to the computing machine 1800 or the processor 1810. The I/O interface 1860 may be configured to communicate data, addresses, and control signals between the peripheral devices, the computing machine 1800, or the processor 1810. The I/O interface 1860 may be configured to implement any standard interface, such as small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 1860 may be configured to implement only one interface or bus technology. Alternatively, the I/O interface 1860 may be configured to implement multiple interfaces or bus technologies. The I/O interface 1860 may be configured as part of, all of, or to operate in conjunction with, the system bus 1820. The I/O interface 1860 may include one or more buffers for buffering transmissions between one or more external devices, internal devices, the computing machine 1800, or the processor 1810.

The I/O interface 1860 may couple the computing machine 1800 to various input devices including cursor control devices, touch-screens, scanners, electronic digitizers, sensors, receivers, touchpads, trackballs, cameras, microphones, alphanumeric input devices, any other pointing devices, or any combinations thereof. The I/O interface 1860 may couple the computing machine 1800 to various output devices including video displays (The computing device 1800 may further include a graphics display, for example, a plasma display panel (PDP), a light emitting diode (LED) display, a liquid crystal display (LCD), a projector, a cathode ray tube (CRT), or any other display capable of displaying graphics or video), audio generation device, printers, projectors, tactile feedback devices, automation control, robotic components, actuators, motors, fans, solenoids, valves, pumps, transmitters, signal emitters, lights, and so forth. The I/O interface 1860 may couple the computing device 1800 to various devices capable of input and out, such as a storage unit. The devices can be interconnected to the system bus 1820 via a user interface adapter, which can include, for example, a Super I/O chip integrating multiple device adapters into a single integrated circuit.

The computing machine 1800 may operate in a networked environment using logical connections through the network interface 1870 to one or more other systems or computing machines across the network 1880. The network 1880 may include a local area network (LAN), a wide area network (WAN), an intranet, an Internet, a mobile telephone network, storage area network (SAN), personal area network (PAN), a metropolitan area network (MAN), a wireless network (WiFi), wireless access networks, a wireless local area network (WLAN), a virtual private network (VPN), a cellular or other mobile communication network, Bluetooth, near field communication (NFC), ultra-wideband, wired networks, telephone networks, optical networks, copper transmission cables, or combinations thereof or any other appropriate architecture or system that facilitates the communication of signals and data. The network 1880 may be packet switched, circuit switched, of any topology, and may use any communication protocol. The network 1880 may comprise routers, firewalls, switches, gateway computers and/or edge servers. Communication links within the network 1880 may involve various digital or analog communication media such as fiber optic cables, free-space optics, waveguides, electrical conductors, wireless links, antennas, radio-frequency communications, and so forth.

Information for facilitating reliable communications can be provided, for example, as packet/message sequencing information, encapsulation headers and/or footers, size/time information, and transmission verification information such as cyclic redundancy check (CRC) and/or parity check values. Communications can be made encoded/encrypted, or otherwise made secure, and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure and then decrypt/decode communications.

The processor 1810 may be connected to the other elements of the computing machine 1800 or the various peripherals discussed herein through the system bus 1820. The system bus 1820 represents one or more of any of several types of bus structures, including a memory bus or memory controller, a peripheral bus, an accelerated graphics port, and a processor or local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. It should be appreciated that the system bus 1820 may be within the processor 1810, outside the processor 1810, or both. According to certain examples, any of the processor 1810, the other elements of the computing machine 1800, or the various peripherals discussed herein may be integrated into a single device such as a system on chip (SOC), system on package (SOP), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those ordinarily skilled in the art will appreciate that one or more aspects of examples described herein may be performed by hardware, software, or a combination thereof, as may be embodied in one or more computing systems. Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

A “server” may comprise a physical data processing system (for example, the computing device 1800 as shown in FIG. 18) running a server program. A physical server may or may not include a display and keyboard. A physical server may be connected, for example by a network, to other computing devices. Servers connected via a network may operate in the capacity of a server machine or a client machine in a server-client network environment, or as a peer machine in a distributed (e.g., peer-to-peer) network environment. The computing device 1800 can include clients’ servers. For example, a client and server can be remote from each other and interact through a network. The relationship of client and server arises by virtue of computer programs in communication with each other, running on the respective computers.

The example systems, methods, and acts described in the examples and described in the figures presented previously are illustrative, not intended to be exhaustive, and not meant to be limiting. In alternative examples, certain acts can be performed in a different order, in parallel with one another, omitted entirely, and/or combined between different examples, and/or certain additional acts can be performed, without departing from the scope and spirit of various examples. Plural instances may implement components, operations, or structures described as a single instance. Structures and functionality that may appear as separate in example embodiments may be implemented as a combined structure or component. Similarly, structures and functionality that may appear as a single component may be implemented as separate components. Accordingly, such alternative examples are included in the scope of the following claims, which are to be accorded the broadest interpretation to encompass such alternate examples. The terminology used herein was chosen to best explain the principles of the embodiments, the practical application or technical improvement over technologies found in the marketplace, or to enable others of ordinary skill in the art to understand the embodiments disclosed herein.

Unless expressly stated otherwise, references to AI, machine learning, predictive models, or natural-language processing herein refer to optional computational techniques that may be employed to implement any of the disclosed functions. Such techniques may be used in combination with, or as alternatives to, rule-based algorithms, deterministic parsing methods, or human-assisted workflows. The system remains operable without the use of AI, and the inclusion of AI-based embodiments does not limit the scope of the disclosed systems or methods.

What is claimed is:

1. A computer-implemented method for automated reservation and schedule management, the computer-implemented method comprising:
by one or more computing devices:
receiving, from a user associated with a user device, a request to reserve a resource;
transmitting a request to the user device to access digital calendars associated with the user device;
scanning online systems of one or more suppliers for availability for the resource;
identifying instances where availability in the digital calendars matches supplier availability for the resource;
transmitting a notice to the user device of the matched resource;
receiving an acceptance of the matched resource by the user;
generating a reservation with supplier system for the matched resource; and
transmitting a booked reservation notice to the user.

2. The computer-implemented method of claim 1, further comprising providing payment of the user in an obfuscated form to the supplier system after generating the reservation.

3. The computer-implemented method of claim 1, further comprising adding the matched resource to the user’s digital calendars.

4. The computer-implemented method of claim 1, wherein the resource comprises at least one of a recreational activity, travel itinerary, lodging, dining, transportation, excursion, event, or sports facility reservation.

5. The computer-implemented method of claim 1, wherein the scanning and identifying are performed continuously or asynchronously to monitor supplier data streams and user calendar updates in real time.

6. The computer-implemented method of claim 1, further comprising generating predictive notifications to the user device based on prior reservation history or stored user preferences.

7. The computer-implemented method of claim 1, further comprising enabling communication between the user and other registered users or suppliers through an integrated community or messaging interface system.

8. A system for automated reservation and schedule management, comprising:
a storage device; and
a processor communicatively coupled to the storage device, wherein the processor executes application code instructions that are stored in the storage device to cause the system to:
receive, from a user associated with a user device, a request to reserve a resource;
transmit a request to the user device to access digital calendars associated with the user device;
scan online systems of one or more suppliers for availability for the resource;
identify instances where availability in the digital calendars matches supplier availability for the resource;
transmit a notice to the user device of the matched resource;
receive an acceptance of the matched resource by the user;
generate a reservation with supplier system for the matched resource; and
transmit a booked reservation notice to the user.

9. The system of claim 8, further comprising application code instructions to cause the system to provide payment information of the user in an obfuscated form to the supplier system after generating the reservation.

10. The system of claim 8, further comprising application code instructions to cause the system to add the matched resource to the user’s digital calendars.

11. The system of claim 8, wherein the resource comprises at least one of a recreational activity, travel itinerary, lodging, dining, transportation, excursion, event, or sports facility reservation.

12. The system of claim 8, wherein the scanning and identifying are performed continuously or asynchronously to monitor supplier data streams and user calendar updates in real time.

13. The system of claim 8, further comprising application code instructions to cause the system to generate predictive notifications to the user device based on prior reservation history or stored user preferences.

14. The system of claim 8, further comprising application code instructions to cause the system to enable communication between the user and other registered users or suppliers through an integrated community or messaging interface system.

15. A computer program product, comprising:
a non-transitory computer-readable storage device having computer-executable program instructions embodied thereon that when executed by a computer cause the computer to generate an automated reservation and manage a schedule, the computer-executable program instructions to:
receive, from a user associated with a user device, a request to reserve a resource;
transmit a request to the user device to access digital calendars associated with the user device;
scan online systems of one or more suppliers for availability of the resource;
identify instances where availability in the digital calendars matches supplier availability for the resource;
transmit a notice to the user device of the matched resource;
receive an acceptance of the matched resource by the user;
generate a reservation with supplier system for the matched resource; and
transmit a booked reservation notice to the user.

16. The computer program product of claim 15, further comprising computer-executable program instructions to provide payment information of the user in an obfuscated form to the supplier system after generating the reservation.

17. The computer program product of claim 15, further comprising computer-executable program instructions to add the matched resource to the user’s digital calendars.

18. The computer program product of claim 15, wherein the resource comprises at least one of a recreational activity, travel itinerary, lodging, dining, transportation, excursion, event, or sports facility reservation.

19. The computer program product of claim 15, wherein the scanning and identifying are performed continuously or asynchronously to monitor supplier data streams and user calendar updates in real time.

20. The computer program product of claim 15, further comprising computer-executable program instructions to generate predictive notifications to the user device based on prior reservation history or stored user preferences.
